(19) United States
(12) Patent Application Publication
(10) Pub. No.: US 2002/0065831 A1
(43) Pub. Date: May 30, 2002

(54) Method and apparatus for providing automated form preparation and processing

(76) Inventor: David John DePaolo, Port Hueneme, CA (US)

Correspondence Address: O'MELVENY & MYERS LLP, 400 So. Hope Street, Los Angeles, CA, 90071-2899, US

(21) Appl. No.: 09/896,141

(22) Filed: Jun. 29, 2001

Related U.S. Application Data
(60) Provisional application No. 60/215,099, filed on Jun. 29, 2000.

(51) Int. Cl. G06F 7/00

(52) U.S. Cl. 707/104.1

(57) ABSTRACT

A system and method is provided for using a processing application to provide populated-form data to a reception device by populating unpopulated-form data with previously stored field data. In a preferred embodiment of the present invention, the processing application is adapted to receive form-request data from a first reception device, where the form-request data corresponds to a first unpopulated-form data. The processing application then provides the first reception device with the first unpopulated-form data, which contains at least one field. The processing application is then adapted to receive at least one field data, where the at least one field data corresponds to the at least one field contained within the first unpopulated-field data. Once the field data has been received, the processing application stores the field data in the database such that the field data is stored uncombined with the unpopulated-form data. The processing application is then adapted to receive form-request data and field-identification data from a second reception device (or the first reception device in a subsequent session), where the form-request data corresponds to a second unpopulated-form data, and the field-identification data corresponds to one of the previously stored field data (e.g., the injured workers name or the claim/case number). Based upon this data (i.e., the form-request data and the field-identification data) the processing application will populate the fields within the second unpopulated-form data with previously stored field data linked to the field data corresponding to the field-identification data. For example, the first or second reception device may provide the processing application with form-request data corresponding to an “affidavit form,” and field-identification data corresponding to a claim number “1234.” The processing application will then populate the fields within the “affidavit form” with previously stored field data linked to the claim number “1234,” which may include, for example, the name of the injured worker, the attorney for the injured worker, etc.

This application claims the benefit pursuant to 35 U.S.C. § 119(e) of U.S. Provisional Application No. 60/215,099, filed Jun. 29, 2000, which application is specifically incorporated herein, in its entirety, by reference.

### COPYRIGHT NOTICE

This patent document contains material subject to copyright protection. The copyright owner, David DePaolo, has no objection to the reproduction of this patent document or any related materials, as they appear in the files of the Patent and Trademark Office of the United States or any other country, but otherwise reserves all rights whatsoever.

### BACKGROUND OF THE INVENTION

1. Field of the Invention

The present invention relates to processing forms over a wide area network such as the Internet, and more particularly, to a system and method for generating and delivering populated forms to a reception device by populating unpopulated “template” forms with provided field data.

2. Description of Related Art

The workers' compensation system is an example of a system, or market that operates almost exclusively through the use of standardized forms. However, because these forms are filled out by numerous parties (i.e., injured worker, doctor, attorneys, employer, insurer, and rehabilitation counselor), duplicative information is entered a number of times by a number of different individuals, thus increasing the time, cost, and probability of errors associated with processing a workers' compensation claim. Further compounding this problem is the fact that claim-specific form documents (i.e., the standardized forms modified to include claim specific information) are typically created in a hard-copy format, thus increasing the cost and time necessary to create, copy, and distribute these documents as required by law.

The severity of this problem can be more easily seen by reviewing a typical workers' compensation claim. During a typical workers' compensation claim, claim-specific form documents are generated by three different groups (i.e., attorneys, doctors, and vocational rehabilitation counselors). The workers' compensation lawyers will generate at least six claim-specific form documents. Additionally, the injured worker's doctor must report (i.e., file a claim-specific form document) every forty-five days while the claim is being litigated, which typically lasts for twelve months (i.e., eight claim-specific form documents). Finally, the vocational rehabilitation counselor must report (i.e., file a claim-specific form document) every thirty days during the rehabilitation phase, which typically lasts for six months (i.e., six claim-specific form documents). Thus, at least sixteen claim-specific form documents, all containing duplicative information, will be filed during a typical worker's compensation claim. Because each one of these claim-specific form documents must be distributed to at least four parties (i.e., the Workers' Compensation Appeals Board (WCAB), the employee's attorney, the employer/insurance carrier's attorney, and the insurance carrier), at least sixty-four claim-specific documents will actually be distributed during a typical workers' compensation claim. In 1998, there were 370,000 new litigated workers' compensation claims filed. This is a gross market of 23,680,000 transactions per year in the state of California alone. For the United States as a whole, the figure is approximately 100 million transactions per year.

The cost associated with these transactions has been researched by West Publishing Group and Coopers & Lybrand. Their results indicated that the cost of processing a single paper form is between $18.00 and $24.00 perform. In contrast, the cost of processing an electronic form is between $1.50 and $2.50 per form. This expense (i.e., generating paper form documents) is duplicated by the doctors, lawyers, and other parties of a workers' compensation claim, and is ultimately absorbed by employers paying increased premiums to insurance companies. Cost savings are a critical aspect of managing any workers' compensation business. By reducing the paperwork, or expediting the processing of paperwork, significant cost savings can be realized.

At present, there is no single clearinghouse (electronic or otherwise) in any state for processing workers' compensation transactions. Although there are some large data warehouses for workers' compensation information, most of the data is either inaccessible in a convenient format or method, or is not consolidated, and consequently makes retrieval and use of such data very expensive. Thus, a need exists, and it would be desirable to have a system and method for consolidating claim-specific data in a centralized location and using that data to electronically populate standardized forms that are used by the parties involved in a workers' compensation claim.

### SUMMARY OF THE INVENTION

The present invention provides a form processing system and method for providing populated-form data to a reception device by populating unpopulated-form data with previously stored field data. In a preferred embodiment of the present invention, the form processing system includes a database, a processing application, and a server adapted to communicate with a plurality of reception devices, through a wide area network, such as the Internet. The processing application is adapted to receive form-request data from a first reception device, where the form-request data corresponds to a first unpopulated-form data (where the unpopulated-form data is preferable in a portable document format (PDF)). In order to simplify this form selection process, the form-request data may further include a first form-request data and a second form-request data, where the first form-request data corresponds to an unpopulated-form type (e.g., legal forms, medical forms, etc.) and the second form-request data corresponds to the first unpopulated-form data (i.e., the specific unpopulated-form document). Alternatively (or additionally), the processing application may further be adapted to receive state-designation data and/or search-criteria data in order to provide at least one reception device with unpopulated-form data pertaining to a particular state and/or a particular search criteria.

Once the processing application receives the form-request data, the processing application is further adapted to provide the first reception device with the corresponding first unpopulated-form data, which further contains at least one field. The processing application is then adapted to receive at least one field data from the first reception device, where the at least one field data corresponds to the at least one field contained within the first unpopulated-field data. Once the field data has been received (which may be indicated by the reception of submit data), the processing application is adapted to store the field data in the database such that the field data is stored uncombined with the unpopulated-form data. This is important because it eliminates the need to resave the first unpopulated-form data, while freeing up the field data so that it can later be used by the processing application to populate other unpopulated-form data.

Once the field data has been stored, the processing application may further be adapted to generate a first populated-form data (i.e., the first unpopulated form data populated with at least one field data), and provide the first populated-form data to a designated reception device. Thus, the first populated-form data can either be downloaded, faxed, emailed, or actually delivery to a designated reception device. If the first populated-form data is being electronically provided to another reception device, the processing application may also be adapted to provide a proof-of-service form together with the first populated-form data in order to satisfies legal requirements associated with the delivery of the first populated-form data.

The processing application is further adapted to receive form-request data and field-identification data from a second reception device (or the first reception device in a subsequent session), where the form-request data corresponds to a second unpopulated-form data (i.e., the specific unpopulated-form document), and the field-identification data corresponds to one of the previously stored field data (e.g., the injured workers name or the claim/case number). Based upon this data (i.e., the form-request data and the field-identification data), the processing application will then populate the fields within the second unpopulated-form data with the previously stored field data linked to the field data corresponding to the field-identification data. For example, the first or second reception device may provide the processing application with form-request data corresponding to an “affidavit form,” and field-identification data corresponding to a claim number “1234.” The processing application will then populate the fields within the “affidavit form” with previously stored field data linked to the claim number “1234,” which may include, for example, the name of the injured worker, the attorney for the injured worker, etc.

In another embodiment, the processing application may further use the “field populating” technique to also calculate a particular value. More particularly, the processing application may be adapted to receive calculation-request data and field-identification data from the reception device, where the calculation-request data corresponds to at least one calculated value (e.g., a weekly compensation rate) and the field-identification data corresponds to a previously stored field data (e.g., the employee's salary). The processing application is then adapted to calculate, and provide to the requesting reception device the at least one calculated value based upon at least one field data linked to the field data corresponding to the field-identification data.

A more complete understanding of the system and method for providing populated-form data to a reception device will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a high level architectural drawing of a system that operates in accordance with one embodiment of the present invention to provide at least one reception device with unpopulated-form data populated with field data.

FIG. 2 is an illustrative example of unpopulated-form data including a plurality of fields.

FIG. 3 is an illustrative example of the unpopulated-form data from FIG. 2, where the plurality of fields are populated with a plurality of field data.

FIG. 4 is an diagram exemplifying what can be done with the unpopulated-form data once it is populated with the plurality of field data.

FIG. 5 is a flow chart illustrating the process of receiving field data and distributing unpopulated-form data populated with the field data.

FIG. 6 is a flow chart illustrating the process of receiving field data and providing at least one calculated value based upon the field data.

### DETAILED DESCRIPTION OF THE PREFERRED EMBODIMENT

The present invention provides a system and method for providing populated-form data to a reception device by populating unpopulated-form data with previously stored field data. In the detailed description that follows, like element numerals are used to describe like elements illustrated in one or more figures.

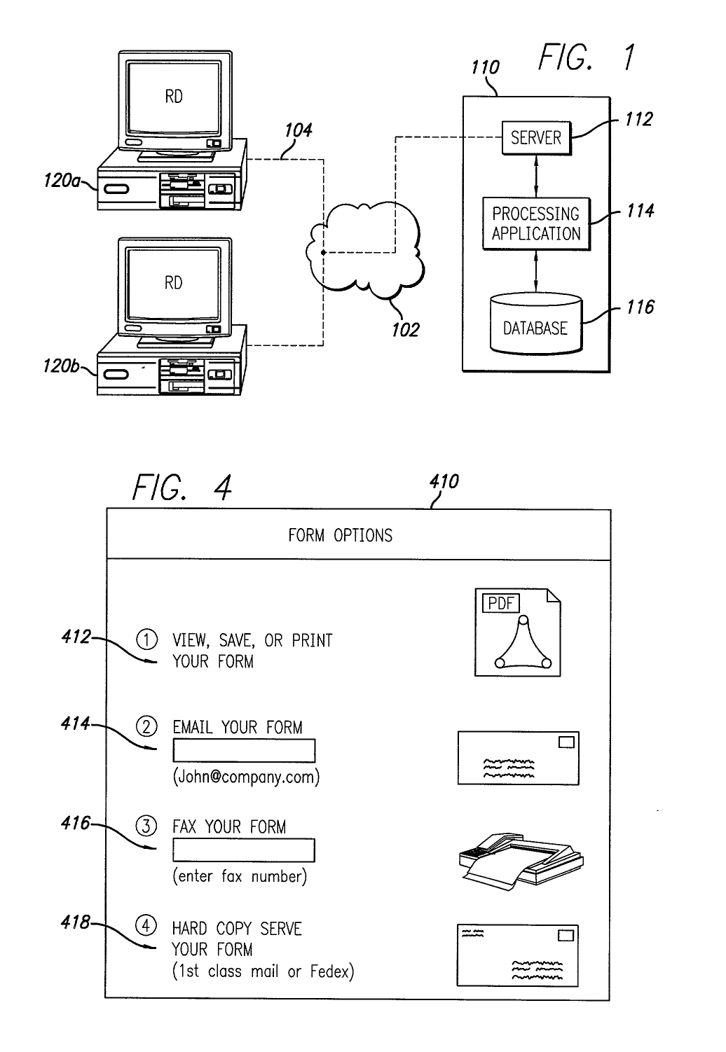

Preferred embodiments of the present invention operate in accordance with a plurality of reception devices and a form processing system adapted to communicate with the plurality of reception devices. FIG. 1 illustrates a preferred embodiment of the form processing system 110 of the present invention. In the preferred embodiment, the form processing system 110 includes a database 116, a processing application 114, and a server 112 adapted to communicate with a plurality of reception devices 120a, 120b, through a wide area network 104, such as the Internet 102.

It should be appreciated that the plurality of reception devices 120a, 120b depicted in FIG. 1 includes, but is not limited to, personal computers, fax machines, printers, personal digital assistances (PDAs), mobile phones, and all other physically and wirelessly connected reception devices generally known to those skilled in the art. It should also be appreciated that the database 116 depicted in FIG. 1 is stored in at least one memory device (not shown), where the memory device includes, but is not limited to, RAM, cache memory, flash memory, magnetic disks, optical disks, removable disks, SCSI disks, IDE hard drives, tapes drives, smart cards, and all other types of data storage devices (and combinations thereof, such as RAID devices) generally known to those skilled in the art. It should also be appreciated that the processing application 114 depicted in FIG. 1 may exist as a single application, or as multiple applications (locally and/or remotely stored) that operate together to perform the required function as described below. It should further be appreciated that the number of components (i.e., server 112, processing application 114, and database 116) depicted within the form processing system 110, and the number of reception devices 120a, 120b depicted in FIG. 1, are merely to illustrate how the invention operates, and are not intended to further limit the invention. Thus, for example, a form processing system 110 having a greater number of components, or adapted to interface with a greater number of reception devices is within the spirit and scope of this invention.

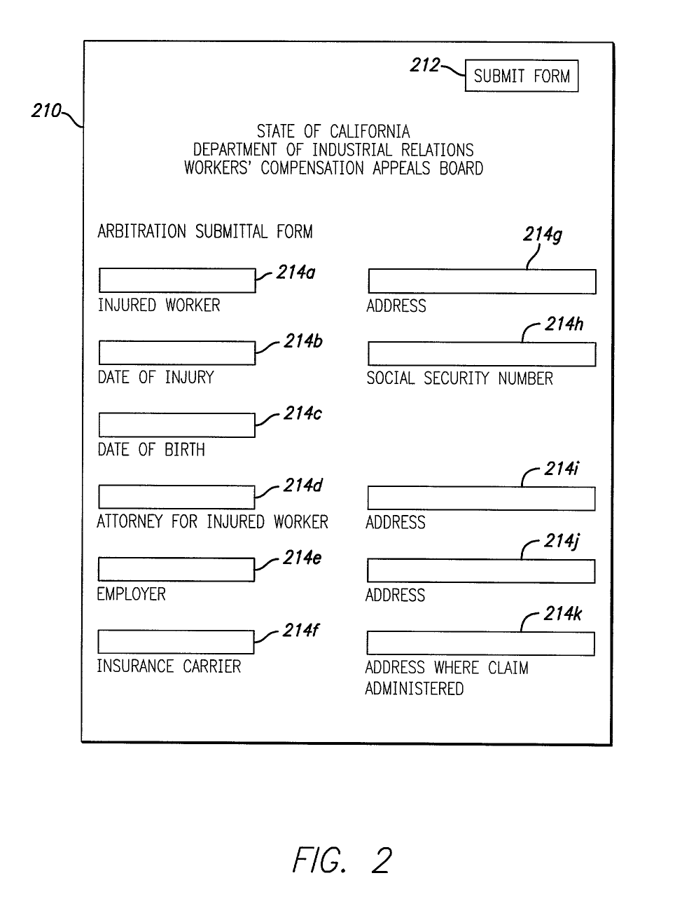

In the preferred embodiment, a plurality of unpopulated-form data are stored in the database 116, where the processing application 114 is adapted to provide a selected ones of the plurality of unpopulated-form data to at least one of the plurality of reception devices (e.g., 120a). More particularly, the processing application 114 is adapted to receive form-request data from a first reception device 120a, where the form-request data corresponds to a first unpopulated-form data (e.g., see FIG. 2). In an effort to simplify the selection process, the form-request data may further include a first form-request data and a second form-request data, where the first form-request data corresponds to an unpopulated-form type and the second form-request data corresponds to the first unpopulated-form data. This allows the first reception device 120a to choose a particular type of form (e.g., legal forms, medical forms, vocational rehabilitation forms, etc.) before selecting the actual form that is desired.

Additional ways of simplifying the selection process are also within the scope of the present invention. More particularly, the processing application 114 may be adapted to receive state-designation data and/or search-criteria data in order to provide at least one reception device (e.g., 120a) with unpopulated-form data pertaining to a particular state and/or a particular search criteria. It should be appreciated that such search criteria may also be used to search for additional data, including, but not limited to code data (e.g., U.S. Codes), regulation data (e.g., U.S. Regulations), bulletin-board data, flow-chart data, or any other data that may aid the operator of the reception device (e.g., 120a) in generating, copying, or distributing populated-form data.

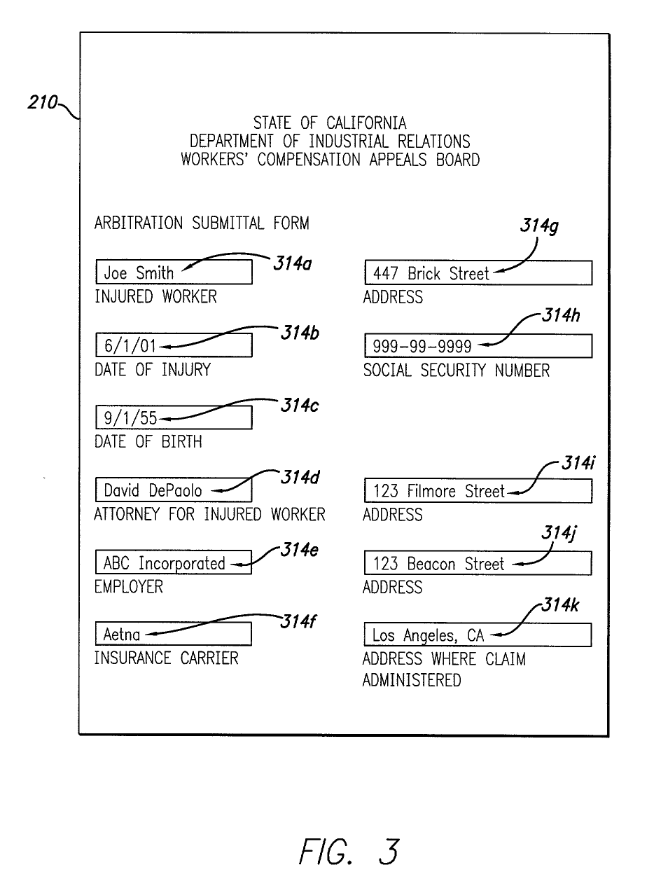

Once the processing application 114 receives the form-request data, the processing application 114 is further adapted to provide the first reception device 120a with the first unpopulated-form data corresponding to the form-request data. An example of unpopulated-form data can be seen in FIG. 2, where the unpopulated form data 210 further contains a plurality of fields (e.g., 214a, 214b, etc.). Referring to FIGS. 1 and 2, the processing application 114 is adapted to receive at least one field data from the first reception device 120a, where the at least one field data corresponds to at least one field (e.g., 214a). An example of at least one field data (e.g., 314a) can be seen in FIG. 3, where the field data (e.g., 314a, 314b, 314c, etc.) may include, but is not limited to the name of the injured employee, the social security number of the injured employee, the case title (i.e., title of the workers' compensation claim), or the case number (i.e., the case number assigned to the worker's compensation claim).

For example, referring to FIGS. 1 and 2, the processing application 114 may provide the first reception device 120a with a first unpopulated-form data 210 that contains an injured worker field 214a and a social security number field 214h. The first reception device 120a can then provide the processing application 114 with field data corresponding to these particular fields. In other words, referring to FIG. 3, the first reception device 120a may provide the processing application 114 with an injured worker field data 314a (i.e., Joe Smith) and a social security number field data 314h (i.e., 999-99-9999), which correspond to the injured worker field 214a and the social security number field 214h, respectively, as depicted in FIG. 2.

To indicate that all the field data (e.g., 314a (Joe Smith), 314h (999-99-9999), etc.) has been provided, the processing application 114 may further be adapted to receive submit data from the first reception device 120a. This may be accomplished by including a “submit form” icon 212 within the unpopulated-form data (e.g., 210), as shown in FIG. 2. Once the field data (or submit data) has been received, the processing application is adapted to store the field data (e.g., 314a) in the database 112, such that the field data (e.g., 314a) is stored uncombined with the unpopulated-form data (e.g., 210). In other words, the first unpopulated-form data 210 does not need be resaved after it has been “modified” by the addition of field data. This is because the field data is stored separately from the unpopulated-form data 210. This is an important aspect of the present invention in two respects: first, it allows the processing application 114 to store the field data (which is a small file) without restoring the first unpopulated-form data (which is an extremely large file), thus improving the speed and size of the form processing system 110; and second, it allows the processing application 114 to use the separate field data to later populate other unpopulated-form data (discussed below).

The efficiency advantages discussed above are perhaps better understood in light of the preferred embodiment. In a preferred embodiment of the present invention, the unpopulated-form data is formatted in a portable document format (PDF), which is often a large file. Thus, the ability to save data (i.e., field data) separate from the unpopulated-form data (i.e., the PDF files) is extremely important. It should be appreciated, however, that although PDF files are a preferred embodiment of the present invention, other document formats generally known to those skilled in the art (e.g., Word, WordPerfect, etc.) are within the spirit and scope of this invention.

Once the field data (e.g., 314a) has been stored (or submitted), the processing application 114 may further be adapted to provide a first populated-form data (which is the first unpopulated form data 210 populated with at least one field data) to a particular reception device (e.g., 120a, 120b). As shown in FIG. 4, the first reception device 120a may choose to send the first populated-form data to itself (i.e., 412) either by saving or printing the document. Additionally, the first reception device 120a may choose to send the first populated-form data to a designated reception device (e.g., 120b), either by emailing the document (i.e., 414), faxing the document (i.e., 416), or having a hard-copy generated and delivered (i.e., 418).

If the first populated-form data is electronically provided to a designated reception device (e.g., by email or fax), the processing application 114 may also be adapted to provide a proof-of-service form to the designated reception device. A proof-of-service form is a form that accompanies legal documents (such as the first populated-form data) in order to verify that the legal documents were actually received by the intended party. To effectuate proper service electronically (i.e., by email or fax), it may be necessary to receive consent to such service before it is performed. In order to do this, the processing application 114 may be adapted to receive user-account data, which would correspond to a user's membership status, or their consent to be served electronically (i.e., by email or fax).

Regardless of whether the first reception device 120a chooses to receive or distribute a copy of the first populated-form data, a second reception device 120b (or the first reception device 120a in a subsequent session) may later provide form-request data and field-identification data to the processing application 114, where the form-request data corresponds to a second unpopulated-form data (not shown), and the field-identification data corresponds to one of the previously stored field data (e.g., “Joe Smith,” “999-99-9999,” etc.). For example, the first or second reception device 120a, 120b may provide the processing application 114 with form-request data corresponding to an “affidavit form” (not shown), and field-identification data corresponding to the social security number field data “999-99-9999” 314h. The processing application 114 will then populate the fields within the “affidavit form” with previously stored field data linked to the social security number field data “999-99-9999” 314h. Thus, previously stored field data, such as the injured worker field data 314a (i.e., Joe Smith), the injured worker's attorney field data 314d (i.e., David DePaolo), can be used to fill in duplicative fields within the second unpopulated-form data (e.g., the affidavit form). This reduces the time, cost, and error probability of creating, copying, and distributing populated-form data. It should be appreciated that the processing application 114 may populate the unpopulated form data before or after it is provided to the reception device. It should also be appreciated that all of the fields within the second unpopulated form data may not be filled with field data if such field data was not previously stored. Thus, half-populated-form data is within the spirit and scope of this invention.

Similar to the concept of using duplicative field data to populate a second unpopulated-form data, the field data may further be used to calculate at least one value. More particularly, the first or second reception device 120a, 120b may provide calculation-request data and field-identification data to the processing application 114, where the calculation-request data corresponds to at least one calculated value (e.g., a weekly compensation rate) and the field-identification data corresponds to a previously stored field data, as previously discussed. The processing application is then adapted to calculate, and provide to the requesting reception device (e.g., 120a, 120b) the at least one calculated value based upon at least one field data linked to the field data corresponding to the field-identification data. For example, if the second reception device 120b provides the processing application 114 with calculation-request data corresponding to the “weekly compensation rate” and field-identification data corresponding to the social security number field data “999-99-9999” 314h, then the processing application 114 is adapted to calculate the “medical compensation value” based in part on field data linked to the social security number field data “999-99-999” 314h. In other words the “medical compensation value” may be based, at least in part, on the date of injury (i.e. “6/1/01” 314b) and/or the address of the employee (i.e., “447 Brick Street” 314g), depending upon whether this field data is relevant to the requested calculation. If the processing application 114 does not have all the information necessary to make the requested calculation (i.e., it has not been previously provided or otherwise available), then the processing application 114 may request additional-field data from the reception device before such calculations can be performed.

In another embodiment, the first or second reception device 120a, 120b may request a calculated value by providing new-field data and calculation-request data to the processing application 114, where the new-field data and calculation-request data correspond to data requested by the processing application for calculation purposes (regardless of whether that data has previously been stored as field data) and at least one calculated value, respectively. The processing application is then adapted to calculate, and provide to the requesting reception device (e.g., 120a, 120b) the at least one calculated value based upon the new-field data, which may include data corresponding to the new-field data. In other words, a calculation may be based upon the actual new-field data (as in the case of salary data) or upon data corresponding to the new-field data (as in the case of occupation data, which may further correspond to mathematical data).

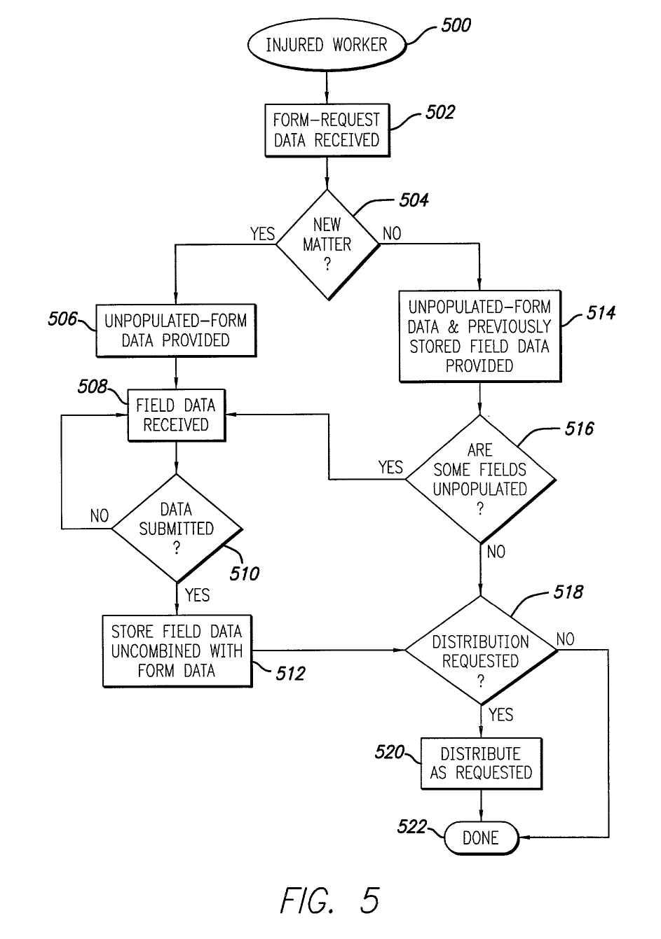

FIG. 5 is flow chart depicting a method for processing unpopulated-form and field data. More particularly, after a worker has been injured at step 500, a party to the workers' compensation claim provides form-request data to the processing system at step 502, thus indicating which unpopulated-form data is being requested. At step 504, the processing system should determine whether the worker's compensation claim at issue constitutes a new matter for the system (i.e., whether field data has previously been stored corresponding to this particular claim). This may be done by requesting field-identification data (e.g., the name or social security number of the injured employee) from the party. If, at step 504, it is determined that this is a new matter (i.e., no field data is stored corresponding to this particular claim), then the requested unpopulated-form data is provided to the party at step 506. The party then provides the system with field data corresponding to a field within the unpopulated-from data at step 508. The party can then either provide submit data, at step 510, or continue to provide field data at step 508 until the field data is ready to be submitted. Once the party provides submit data at step 510, then the processing system stores the provided field data at step 512, such that field data is uncombined with the unpopulated-form data. The processing system should then determine whether the party would like the populated-form data distributed to additional parties (or to themselves) at step 518. If the answer is NO, then the process is finished at step 522. If the answer is YES, then the populated-form data is distributed as requested at step 520, and the process is finished at step 522.

Referring back to step 504, if the answer is NO (i.e., this is not a new matter), then the requested unpopulated-form data is provided to the party at step 514, at least partially populated with previously stored field data. The system should then determine whether there are “blank” fields within the unpopulated form (i.e., field data is needed) at step 516. If the answer is YES then field data is received at step 508, and the process continues as previously discussed. If the answer is NO, then the system should determine whether the party would like the populated-form data distributed to at least one additional party (or themselves) at step 518. If the answer is NO, then the process is finished at step 522. If the answer is YES, then the populated-form data is distributed as requested at step 520, and the process is finished at step 522.

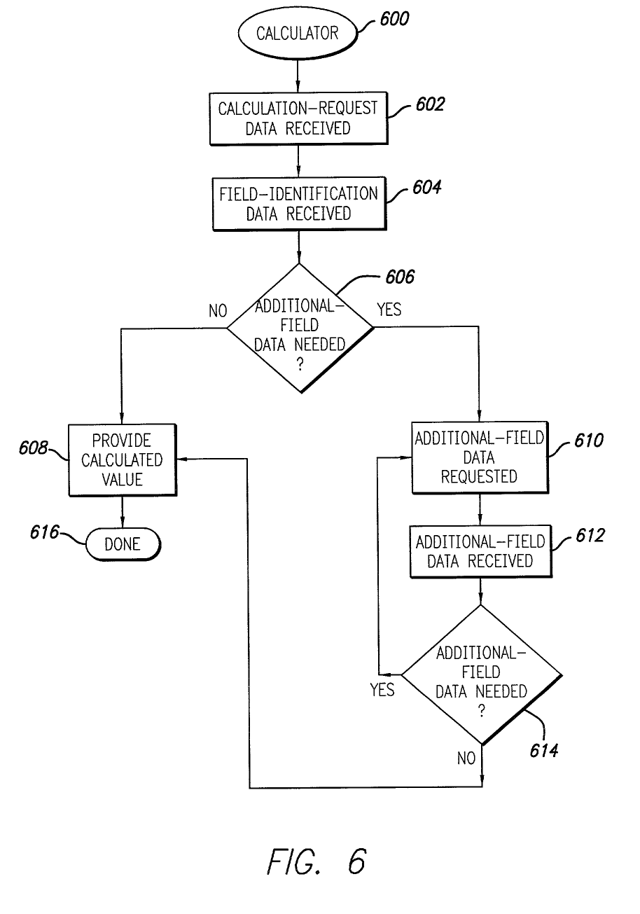

FIG. 6 is a flow chart depicting a preferred method for calculating at least one calculated value. More particularly, starting at step 600, the processing system receives calculation-request data from a party at step 602, where the calculation-request data corresponds to a calculated value that is being requested. At step 604, the processing system receives field-identification data in order to determine what field data the calculated value is based upon. At step 606, the processing system should determine whether additional-field data is needed in order to make the requested calculation. If the answer is NO, the calculations are made, and the calculated values are provided to the party at step 608, which finishes the process at step 616. On the other hand, if the answer (at step 606) is YES, then additional-field data is requested from the party at step 610. At step 612, the additional-field data is received. The processing system should then again determine whether additional-field data is needed in order to make the requested calculation. If the answer is NO, the calculations are made, and the calculated values are provided to the party at step 608, which finishes the process at step 616. If the answer (at step 614) is YES, then additional-field data is requested at step 610, and the cycle repeats until enough data is available to make the requested calculation.

Having thus described a preferred embodiment of a system and method for providing populated-form data to a reception device, it should be apparent to those skilled in the art that certain advantages of the system have been achieve. It should also be appreciated that various modifications, adaptations, and alternative embodiments thereof may be made within the scope and spirit of the present invention. The invention is further defined by the following claims.

What is claimed is:

1. A form processing system comprising:
a database for storing a plurality of unpopulated form data;
a server adapted to communicate with a plurality of reception devices; and
a processing application connected to said database, wherein said processing application is adapted to:
receive form-request data from a first one of said plurality of reception devices, said form-request data corresponding to a first unpopulated-form data;
provide said first unpopulated-form data to said first one of said plurality of reception devices;
receive at least one field data from said first one of said plurality of reception devices, said at least one field data corresponding to at least one field within said first unpopulated-form data;
store said at least one field data uncombined with said first unpopulated-form data in said database;
generate a second populated-form data by populating at least one field within a second unpopulated-form data with said at least one field data; and
provide said second populated-form data to at least one of said plurality of reception devices, wherein said at least one of said plurality of reception devices is selected from a group of reception devices consisting of said first one of said plurality of reception devices and any other one of said plurality of reception devices.

2. The form processing system of claim 1, wherein said first and second unpopulated-form data further comprises a PDF format.

3. The form processing system of claim 1, wherein said form-request data further comprises a first form-request data and a second form-request data, wherein said first form-request data corresponds to an unpopulated-form type and said second form-request data corresponds to said first unpopulated-form data.

4. The form processing system of claim 3, wherein said unpopulated-form type is selected from a list consisting of legal forms, medical forms, and vocational rehabilitation forms.

5. The form processing system of claim 1, wherein said at least one field data is selected from a list consisting of social security number, employee name, case title, and case number.

6. The form processing system of claim 1, wherein said processing application is further adapted to receive submit data from said first one of said plurality of reception devices before said processing application stores said at least one field data in said database.

7. The form processing system of claim 1, wherein said processing application is further adapted to receive field-identification data and form-request data from said at least one of said plurality of reception devices, said field-identification data and said form-request data corresponding to one of said at least one field data and said second unpopulated-form data, respectively.

8. The form processing system of claim 1, wherein said field-identification data is selected from a list consisting of social security number, employee name, case title, and case number.

9. The form processing system of claim 1, wherein said processing application is further adapted to:
generate a first populated-form data by populating said at least one field within said first unpopulated-form data with said at least one field data; and
provide said first populated-form data to said first one of said plurality of reception devices.

10. The form processing system of claim 1, wherein said processing application is further adapted to:
receive distribution data from said first one of said plurality of said reception devices, said distribution data corresponding to at least one other one of said plurality of reception devices;
generate a first populated-form data by populating said at least one field within said first unpopulated-form data with said at least one field data; and
provided said first populated-form data to said at least one other one of said plurality of reception devices;

11. The form processing system of claim 10, wherein said first populated-form data is provided via email.

12. The form processing system of claim 10, wherein said at least one other one of said plurality of reception devices further comprises a fax machine.

13. The form processing system of claim 10, wherein said processing application is further adapted to provide a proof-of-service form to said at least one other one of said plurality of reception devices, said proof-of-service form satisfying legal requirements associated with the delivery of said unpopulated-form data populated with said at least one field data.

14. The form processing system of claim 13, wherein said proof-of-service form is provided via email.

15. The form processing system of claim 1, wherein said processing application is further adapted to receive user-account data from said at least one of said plurality of reception devices, said user-account data corresponding to a membership status of a user operating said at least one of said plurality of reception devices.

16. The form processing system of claim 1, wherein said processing application is further adapted to receive state-designation data from said first one of said plurality of reception devices, said state-designation data being used by said processing application to provide said first one of said plurality of reception devices with unpopulated-form data pertaining to a particular state.

17. The form processing system of claim 1, wherein said processing application is further adapted to receive search-criteria data from said first one of said plurality of reception devices, said search-criteria data being used by said processing application to search for data stored in said database.

18. The form processing system of claim 17, wherein said data is selected from a list consisting of unpopulated-form data, code data, regulation data, bulletinboard data, and flow-chart data.

19. The form processing system of claim 1, wherein said processing application is further adapted to:
receive calculation-request data and at least one new-field data from said at least one of said plurality of reception devices, said calculation-request data corresponding to at least one calculated value;
calculate said at least one calculated value using at least said at least one new-field data; and
provide said at least one calculated value to said at least one of said plurality of reception devices.

20. The form processing system of claim 1, wherein said processing application is further adapted to:
receive calculation-request data and field-identification data from said at least one of said plurality of reception devices, said calculation-request data and said field-identification data corresponding to at least one calculated value and one of said at least one field data, respectively;
calculate said at least one calculated value using at least one field data linked with said one of said at least one field data; and
provide said at least one calculated value to said at least one of said plurality of reception devices.

21. The form processing system of claim 19, wherein said processing application is further adapted to request additional-field data, wherein said at least one calculated value is calculated using said at least one field data linked with said one of said at least one field data and said additional-field data.

22. A method for processing forms comprising the steps of:
receiving form-request data from a first reception device, said form-request data corresponding to a first unpopulated-form data;
providing said first unpopulated-form data to said first reception device;
receiving at least one field data from said first reception device, said at least one field data corresponding to at least one field within said first unpopulated-form data;
storing said at least one field data uncombined with said first unpopulatedform data;
generating a second populated-form data by populating at least one field within a second unpopulated-form data with said at least one field data; and
providing said second populated-form data to at least one of a plurality of reception devices, wherein said plurality of reception devices consists of said first reception device and at least one other reception device.

23. The method of claim 22, wherein said steps of providing said first and second unpopulated-form data further comprises providing said first and second unpopulated-form data in a PDF format.

24. The method of claim 22, wherein said step of receiving form-request data further comprises receiving a first form-request data and a second form-request data, wherein said first form-request data corresponds to an unpopulated-form type and said second form-request data corresponds to said first unpopulated-form data.

25. The method of claim 24, wherein said step of receiving said first formrequest data further comprises receiving data corresponding to one of a plurality of unpopulated-form types consisting of legal forms, medical forms, and vocational rehabilitation forms.

26. The method of claim 22, wherein said step of receiving said at least one field data further comprises receiving at least one data from a plurality of field data consisting of social security number, employee name, case title, and case number.

27. The method of claim 22, further comprising the step of receiving submit data before said at least one field data is stored.

28. The method of claim 22, further comprising the step of receiving field-identification data and form-request data from said at least one of a plurality of reception devices, wherein said field-identification data and said form-request data correspond to one of said at least one field data and said second unpopulated-form data, respectively.

29. The method of claim 28, wherein said step of receiving field-identification data further comprising receiving one data from a plurality of field data consisting of social security number, employee name, case title, and case number.

30. The method of claim 22, further comprising the steps of:
generating a first populated-form data by populating said at least one field within said first unpopulated-form data with said at least one field data; and
providing said first populated-form data to said first reception device.

31. The method of claim 22, further comprising the steps of:
receiving distribution data from said first reception device, said distribution data corresponding to at least one other reception device;
generating a first populated-form data by populating said at least one field within said first unpopulated-form data with said at least one field data; and
providing said first populated-form data to said at least one other reception device.

32. The method of claim 31, wherein said step of providing said first populated-form data further comprising providing said first populated-form data to said at least one other reception device via email.

33. The method of claim 31, further comprising the step of providing a proof-of-service form to said at least one other reception device, said proof-of-service form satisfying legal requirements associated with the delivery of said first unpopulated-form data populated with said at least one field data.

34. The method of claim 33, wherein said step of providing said proof-of-service form further comprises providing said proof-of-service form to said at least one other reception device via email.

35. The method of claim 22, further comprising the step of receiving user-account data from said at least one of a plurality of reception devices, said user-account data corresponding to a membership status of a user operating said at least one of a plurality of reception devices.

36. The method of claim 22, further comprising the step of receiving state-designation data from a first reception device, said state-designation data being used to provide said first reception device with a list of unpopulated-form data pertaining to a particular state.

37. The method of claim 22, further comprising the steps of:
receiving search-criteria data from said first reception device; and
searching for data pertaining to said search-criteria data.

38. The method of claim 37, wherein said step of searching for said data further comprises searching for at least one data from a plurality of data consisting of unpopulated-form data, code data, regulation data, bulletin-board data, and flow-chart data.

39. The method of claim 22, further comprising the steps of:
receiving calculation-request data and at least one new-field data from said at least one of a plurality of reception devices, said calculation-request data corresponding to at least one calculated value;
calculating said at least one calculated value using at least said at least one new-field data; and
providing said at least one calculated value to said at least one of a plurality of reception devices.

40. The method of claim 22, further comprising the steps of:
receiving calculation-request data and field-identification data from said at least one of a plurality of reception devices, said calculation-request data and said field-identification data corresponding to at least one calculated value and one of said at least one field data, respectively;
calculating said at least one calculated value using at least one field data linked to said one of said at least one field data; and
providing said at least one calculated value to said at least one of a plurality of reception devices.

41. The method of claim 40, further comprising the step of requesting additional-field data, wherein said step of calculating said at least one field data further comprises calculating said at least one calculated value using said at least one field data linked to said one of said at least one field data and said additional-field data.
